(19) United States
(12) Patent Application Publication
(10) Pub. No.: US 2019/0361744 A1
(43) Pub. Date: Nov. 28, 2019

(54) INFORMATION PROCESSING APPARATUS AND NON-TRANSITORY COMPUTER-READABLE RECORDING MEDIUM STORING CONTROL PROGRAM

(71) Applicant: FUJITSU LIMITED, Kawasaki-shi (JP)

(72) Inventor: Takafumi Koda, Kawasaki (JP)

(73) Assignee: FUJITSU LIMITED, Kawasaki-shi (JP)

(21) Appl. No.: 16/402,279

(22) Filed: May 3, 2019

(30) Foreign Application Priority Data
May 25, 2018 (JP) 2018-100378

(51) Int. Cl. G06F 9/50; G06F 1/329

(52) U.S. Cl. CPC G06F 9/5038; G06F 2209/5021; G06F 1/329

(57) ABSTRACT

An information processing apparatus includes a memory; and a plurality of processors coupled to the memory wherein one of the plurality of processors configured to set an allocation order with respect to the plurality of processors based on an operating mode set in relation to a plurality of characteristics on the plurality of processors, and allocate the plurality of processors to processes according to the allocation order.

### CROSS-REFERENCE TO RELATED APPLICATION

This application is based upon and claims the benefit of priority of the prior Japanese Patent Application No. 2018-100378, filed on May 25, 2018, the entire contents of which are incorporated herein by reference.

### FIELD

The embodiments discussed herein are related to an information processing apparatus and a non-transitory computer-readable recording medium storing a control program.

### BACKGROUND

In an information processing apparatus in which plural central processing units (CPUs) are mounted and each CPU includes plural cores (CPU cores), the cores are allocated to each request (process) of a user of the corresponding information processing apparatus.

With respect to the allocation of the cores, the user may set priorities by using a start-up program of the information processing apparatus, such as a basic input/output system (BIOS). As priority options that can be set by the user, there are, for example, an option to prioritize improvement of a performance (high performance) and an option to prioritize reduction of power (power saving), both of which set a processing environment of processes in the corresponding information processing apparatus.

An operating system (OS) performs a control of allocating each core to each process in a predetermined order so that the process is performed according to the priorities set by the user. In such a control, in some cases, an allocation of the core to the process is performed on the basis of the specifications of each core at the time of shipment (e.g., a benchmark result), or a core to which no process is allocated (empty) is preferentially allocated to a process.

Related techniques are disclosed in, for example, Japanese Laid-open Patent Publication Nos. 2017-076414 and 2007-299346.

### SUMMARY

According to an aspect of the embodiments, an information processing apparatus includes a memory; and a plurality of processors coupled to the memory, wherein one of the plurality of processors configured to: set an allocation order with respect to the plurality of processors based on an operating mode set in relation to a plurality of characteristics on the plurality of processors, and allocate the plurality of processors to processes according to the allocation order.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating a hardware configuration of an information processing apparatus as an example of an embodiment;

FIG. 2 is a view illustrating a functional configuration of the information processing apparatus as an example of the embodiment;

FIG. 3 is a view illustrating CPU identification information in the information processing apparatus as an example of the embodiment;

FIG. 4 is a view illustrating CPU management information in the information processing apparatus as an example of the embodiment;

FIG. 5 is a view illustrating prioritization rule definition in the information processing apparatus as an example of the embodiment;

FIG. 6 is a view illustrating a processing at the time of power-on control in the information processing apparatus as an example of the embodiment;

FIG. 7 is a view illustrating prioritization rule definition in the information processing apparatus as an example of the embodiment;

FIGS. 8A, 8B and 8C are views illustrating rewriting of CPU management information in the information processing apparatus as an example of the embodiment;

FIG. 9 is a view illustrating a control processing at the time of power-on in the information processing apparatus as an example of the embodiment;

FIG. 10 is a view illustrating a control processing according to re-measurement of a performance in the information processing apparatus as an example of the embodiment;

FIG. 11 is a view illustrating a control processing according to a change of priority setting information in the information processing apparatus as an example of the embodiment;

FIG. 12 is a view illustrating a control processing at the time of power-on in the information processing apparatus as a modification;

FIG. 13 is a view illustrating the results obtained when characteristics of a CPU in the information processing apparatus as the modification are measured;

FIGS. 14A and 14B are views illustrating rewriting of CPU management information in the information processing apparatus as the modification; and

FIGS. 15A and 15B are views illustrating rewriting of CPU management information in the information processing apparatus as the modification.

### DESCRIPTION OF EMBODIMENTS

In such a core allocation method of the related art, in order to take into consideration individual differences (variations) between the cores, actual measurement values related to the characteristics of each core are obtained, and an allocation of the cores to a process is performed on the basis of differences between the specifications and the actual measurement values of each core. However, in such a core allocation method, a priority selected by a user is not taken into consideration. Thus, there is a problem in that a processing of processes becomes difficult in an environment desired by the user.

Hereinafter, an embodiment of the present disclosure will be described with reference to the accompanying drawings. However, the embodiment described below is merely exemplary, and there is no intention to exclude the application of various modifications or techniques not explicitly stated below. For example, the present embodiment may be implemented through various modifications without departing the spirit. In drawings used in the following embodiment, portions that are given the same numerals indicate the same or similar portions unless otherwise specified.

### Configuration Example of Information Processing Apparatus According To Embodiment

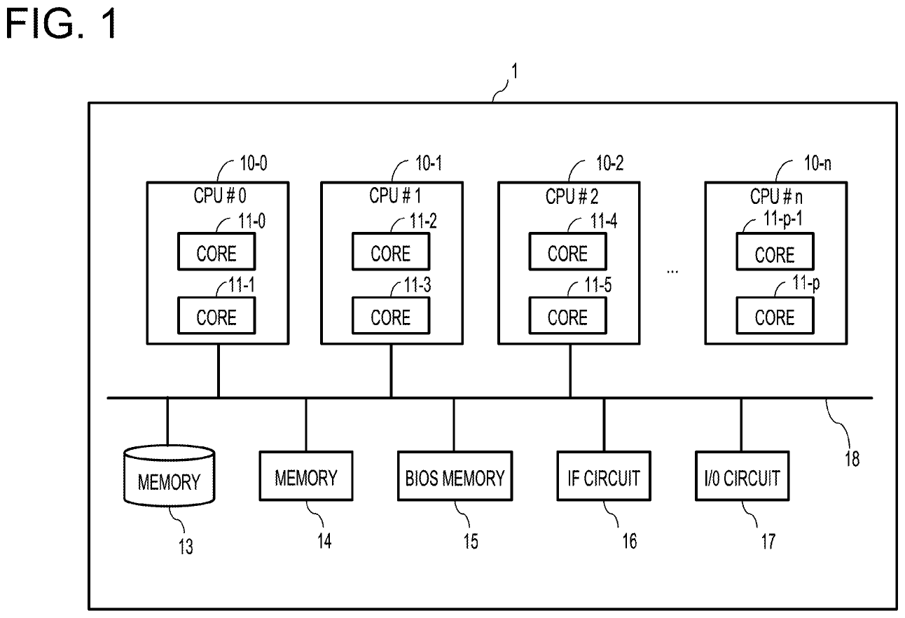

FIG. 1 is a view illustrating a hardware configuration of an information processing apparatus 1 as an example of an embodiment.

As illustrated in FIG. 1, the information processing apparatus 1 may include a CPU#0 to a CPU#n (n is an integer of 0 or more), as a multi-core configuration including a plurality of cores (CPU cores) 11. The information processing apparatus 1 may include a storage 13, a memory 14, a BIOS memory 15, an interface (IF) unit 16, and an input/output (I/O) unit 17.

Specifically, the information processing apparatus 1 includes one or more CPUs, that is, a CPU 10-0, a CPU 10-1, a CPU 10-2, . . . , a CPU 10-n. Hereinafter, when it is necessary to specify one of a plurality of CPUs, numerals 10-0, 10-1, 10-2, . . . , 10-n are used as numerals indicating the CPUs, whereas the numeral 10 is used in order to indicate an arbitrary CPU. The CPU 10-0, the CPU 10-1, . . . , and the CPU 10-n are also represented by a CPU#0, a CPU#1, . . . , and a CPU#n, respectively, and the numerals attached to a sign “#,” that is, “0,” “1,” . . . , “n,” are also simply referred to as physical CPU numbers. These CPUs 10 are connected with each other via a bus 18 so as to communicate with each other.

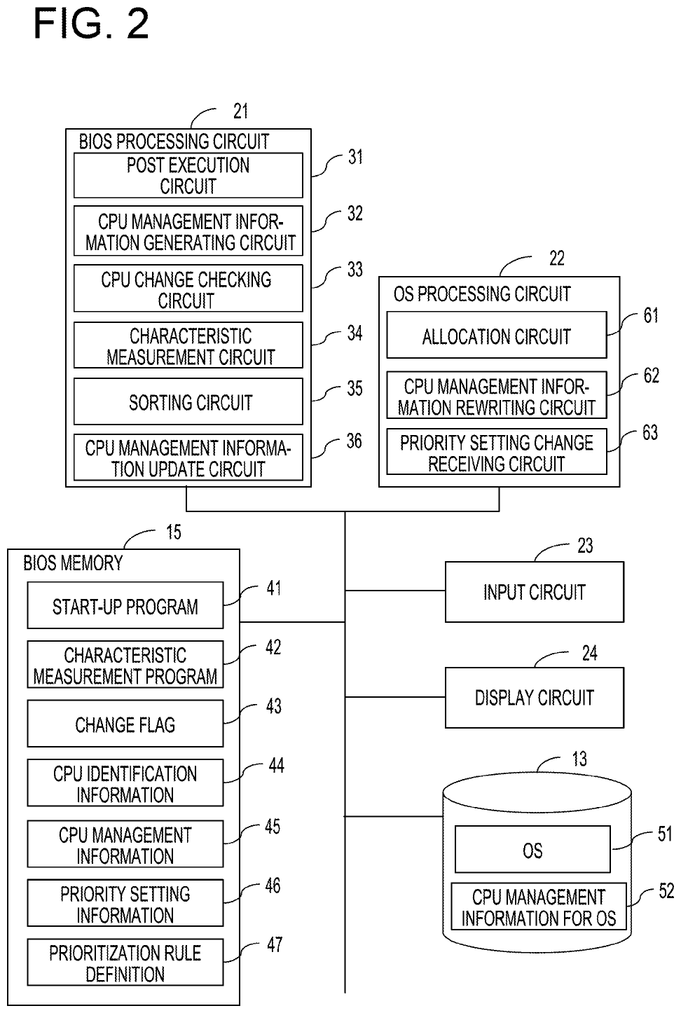

The CPU 10 executes an OS or programs stored in the storage 13 to be described below, and controls, for example, the information processing apparatus 1 so as to process the processes input from a user. In the present embodiment, the CPU 10 (the core 11) executes a start-up program 41 and a characteristic measurement program 42 to be described below with reference to FIG. 2, etc.

The CPU 10 has a multi-core configuration, and in the present embodiment, it is assumed that each CPU 10 includes two cores 11. As illustrated in FIG. 1, the CPU#0 includes two cores 11, that is, a core 11-0 and a core 11-1. Similarly, the CPU#1 includes a core 11-2 and a core 11-3, the CPU#2 includes a core 11-4 and a core 11-5, and the CPU#n includes a core 11-p−1 (p is an integer of 0 or more) and a core 11-p.

Hereinafter, when it is necessary to specify one of a plurality of cores, numerals 11-0, 11-1, . . . , and 11-p are used as numerals indicating cores, whereas a numeral 11 is used in order to indicate an arbitrary core. In the present embodiment, each CPU 10 includes two cores 11, but each CPU 10 may include two or more cores 11.

The storage 13 is an example of hardware that stores various data or programs etc. For example, the storage 13 may be used as a secondary storage device of the information processing apparatus 1, and may store programs such as an OS, firmware, or applications, and various data. As for the storage 13, for example, not only a magnetic disk device such as a hard disk drive (HDD), but also a semiconductor storage device such as a solid state drive (SSD) or a storage class memories (SCM) may be exemplified. The storage 13 may store a program that implements all or a part of various functions of the information processing apparatus 1.

The memory 14 is an example of hardware that stores various data or programs. As the memory 14, a volatile memory, for example, a RAM such as a dynamic RAM (DRAM) may be exemplified. The RAM is an abbreviation of a random access memory.

The BIOS memory 15 is an example of hardware that stores various data related to a start program (the start-up program 41 to be described below) such as a BIOS or the start program itself. As for the BIOS memory 15, for example, a non-volatile memory may be exemplified.

The IF unit 16 is an example of a communication interface that performs a control etc. of connection and communication with respect to an external device (not illustrated) via an external network, etc.

The I/O unit 17 may include, for example, at least one of an input device such as a mouse or a keyboard, and an output device such as a display or a speaker.

The bus 18 connects the CPUs 10 to each other in a communicable manner, and connects the CPUs 10 to the storage 13, the memory 14, the BIOS memory 15, the IF unit 16, and the I/O unit 17.

### Functional Configuration Example in Information Processing Apparatus According to Embodiment

FIG. 2 is a view illustrating a functional configuration of the information processing apparatus 1, as an example of the embodiment illustrated in FIG. 1.

As illustrated in FIG. 2, the information processing apparatus 1 may include, for example, a BIOS processor 21, an OS processor 22, an input unit 23, and a display 24.

The input unit 23 implements the input of a request or a setting change by the user by using an input device such as a mouse or a keyboard.

The display 24 implements displaying of information to the user by using an output device such as a display or a speaker.

As illustrated in FIG. 2, the BIOS memory 15 may include the start-up program 41, the characteristic measurement program 42, a change flag 43, CPU identification information 44, CPU management information 45, priority setting information 46, and prioritization rule definition 47. The start-up program 41 is executed by the BIOS processor 21, and the characteristic measurement program 42 is executed by the core 11. The BIOS processor 21 is executed by the CPU 10 (the primary CPU 10) as one of the plurality of CPUs 10. The change flag 43, the CPU identification information 44, the CPU management information 45, the priority setting information 46, and the prioritization rule definition 47 correspond to information referenced when the BIOS processor 21 executes the start-up program 41, and the characteristic measurement program 42.

The start-up program 41 is a program that implements a processing according to start-up of the information processing apparatus 1 such as a BIOS, and is executed, for example, by power-on as a trigger.

The characteristic measurement program 42 is a program that measures a plurality of characteristics of the cores 11 included in each CPU 10, and for example, causes each core 11 to execute a specific instruction sequence for a predetermined time. In the present embodiment, as the characteristic measurement program 42, a known benchmark program may be used. In the present embodiment, it is assumed that a maximum frequency and a power consumption are measured as characteristics, and measurement values of the maximum frequency and the power consumption are also referred to as operation unit characteristic information. A method or a program of measuring these characteristics (the maximum frequency and the power consumption) is known, and thus descriptions thereof will be omitted herein.

The change flag 43 indicates whether there is a change in the configuration of the CPUs 10 provided in the information processing apparatus 1 (e.g., the combination or number of the CPUs 10) due to exchange etc. of the CPUs 10. It is assumed that when there is a change in the CPUs 10, “1” is stored in the change flag 43, and when there is no change, “0” is stored in the change flag 43. In the present embodiment, at the time of first start-up (factory shipment), it is assumed that “1” is stored in the change flag 43.

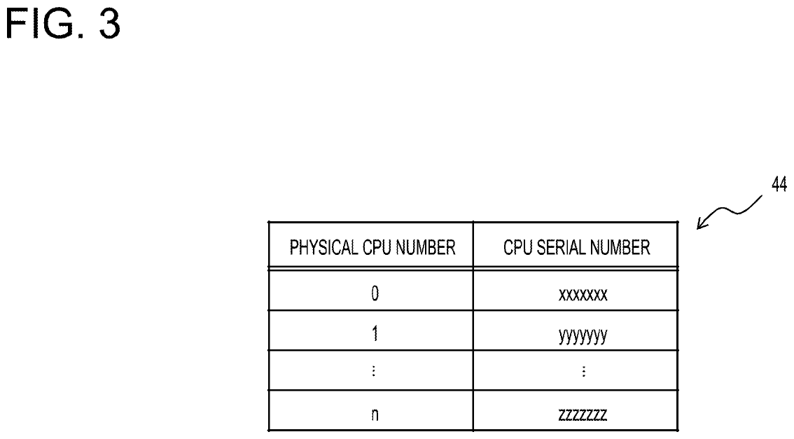

The CPU identification information 44 manages identification information of each CPU 10 mounted in the information processing apparatus 1. The CPU identification information 44 will be described with reference to FIG. 3.

FIG. 3 is a view illustrating the CPU identification information 44 in the information processing apparatus 1, as an example of the embodiment. In the present embodiment, in the example illustrated in FIG. 3, the CPU identification information 44 is expressed in a table format. However, the expression format of information stored in the CPU identification information 44 is not limited to a table, and may be implemented through various modifications.

The CPU identification information 44 illustrated in FIG. 3 includes fields of a “physical CPU number” and a “CPU serial number.”

The “physical CPU number” field of the CPU identification information 44 stores an identifier (ID) that uniquely specifies the CPU 10, and stores an integer from “0” to “n.” For example, as the “physical CPU numbers” of the CPU#0 (10-0) and the CPU#1 (10-1) illustrated in FIG. 1, “0” and “1” are stored, respectively, in the “physical CPU number” field of the CPU identification information 44.

The “CPU serial number” field of the CPU identification information 44 stores a serial number (number) of the CPU 10. The number of digits of the serial number stored in the “CPU serial number” field is arbitrary.

At the time of first start-up of the information processing apparatus 1, it is assumed that “NULL” is stored in the fields of the “physical CPU number” and the “CPU serial number” of the CPU identification information 44.

FIG. 3 illustrates that the CPU 10 having a physical CPU number of “0” has a serial number “xxxxxxx.”

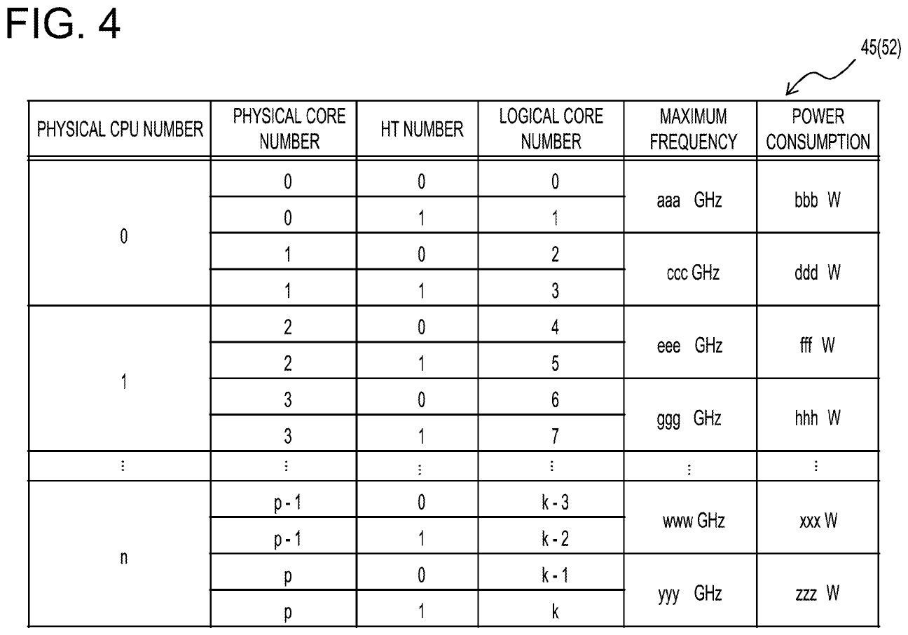

Referring back to the description on the functional configuration of the BIOS memory 15 illustrated in FIG. 2, descriptions will be made on the CPU management information 45. The CPU management information 45 manages information of the core 11 provided in each CPU 10. The CPU management information 45 will be described with reference to FIG. 4.

FIG. 4 is a view illustrating the CPU management information 45 in the information processing apparatus 1 as an example of the embodiment. In the present embodiment, in the example illustrated in FIG. 4, the CPU management information 45 is expressed in a table format. However, the expression format of information stored in the CPU management information 45 is not limited to a table, and may be implemented through various modifications.

The CPU management information 45 illustrated in FIG. 4 includes fields of a “physical CPU number,” a “physical core number,” a “HT number,” a “logical core number,” a “maximum frequency”, and a “power consumption.” The “HT” is an abbreviation of a hyper-threading technology.

The “physical CPU number” field of the CPU management information 45 stores an identifier (ID) that uniquely specifies the CPU 10, and stores an integer from “0” to “n.” For example, for the CPU#0 (10-0) and the CPU#1 (10-1) in FIG. 1, as illustrated in FIG. 4, “0” and “1” are stored, respectively, in the “physical CPU number” field of the CPU management information 45.

The “physical core number” field of the CPU management information 45 stores identifiers (IDs) that uniquely specify the cores 11 provided in all the CPUs 10, and stores integers from “0” to “p.” In the present embodiment, the core 11 provided in each CPU 10 is also simply referred to as a core 11, or a physical core 11.

In 11-0 to 11-p as numerals indicating the cores, integers 0 to p attached after a sign “-(hyphen)” correspond to physical core numbers (IDs).

In the present embodiment, since it is assumed that two cores 11 are provided in each CPU 10, as illustrated in the CPU management information 45 of FIG. 4, for example, for the CPU#0 having “0” in the “physical CPU number” field, “0” or “1” is stored in the “physical core number.” Similarly, for the CPU#1 having “1” as the physical CPU number, “2” or “3” is stored in the “physical core number”, and for the CPU#n having “n” as the physical CPU number, “p−1” or “p” is stored in the “physical core number”.

The “HT number” field of the CPU management information 45 stores an identifier (ID) that uniquely specifies a plurality of virtual cores when each physical core 11 functions as these virtual cores. In the present embodiment, the virtual core is also referred to as a logical core.

In the present embodiment, since it is assumed that two logical cores are allocated to each physical core 11, “0” or “1” is stored in the “HT number” field of the CPU management information 45. Specifically, for each physical core number, “0” and “1” are set, respectively, in the HT numbers. In the present embodiment, as illustrated in the CPU management information 45 of FIG. 4, for example, “0” and “1” as the “HT numbers” are allocated, respectively, to two logical cores corresponding to the physical core 11 having “0” as the physical core number.

The “logical core number” field of the CPU management information 45 stores identifiers (IDs) that uniquely specify the logical cores provided in all the CPUs 10. In the present embodiment, integers from “0” to “k” are stored in the “logical core number” field.

As illustrated in FIG. 4, two logical cores are allocated to each physical core 11. For example, between the two logical cores having “0” as the physical core number, for the logical core having “0” as the “HT number,” “0” is stored in the “logical core number,” and for the logical core having “1” as the “HT number,” “1” is stored in the “logical core number.” Between the logical cores of the CPU#0, which have “1” as the physical core number, for the logical core having “0” as the “HT number,” “2” is stored in the “logical core number” field, and for the logical core having “1” as the “HT number,” and “3” is stored in the “logical core number” field.

A value stored in the “logical core number” field of the CPU management information 45 corresponds to the order when the logical core of the CPU 10 is executed, and the smaller the value stored in the “logical core number,” the faster a process is allocated. That is, the value stored in the “logical core number” field of the CPU management information 45 indicates an allocation order of the respective cores 11 to a plurality of processes.

The “maximum frequency” field of the CPU management information 45 stores a maximum frequency of each core 11, which is obtained as a result of execution of the characteristic measurement program 42. In the present embodiment, the unit of the maximum frequency is “GHz.” However, the present disclosure is not limited thereto, and various modifications may be implemented. The CPU management information 45 in FIG. 4 indicates that, for example, the maximum frequency of the core 11 having “0” as the physical core number is “aaa GHz.”

The “power consumption” field of the CPU management information 45 stores power consumption of each core 11, which is obtained as a result of execution of the characteristic measurement program 42. In the present embodiment, the unit of the power consumption is “W”. However, the present disclosure is not limited thereto, and various modifications may be implemented. The CPU management information 45 in FIG. 4 indicates that, for example, the power consumption of the core 11 of the CPU#0, with “0” as the physical core number, is “bbb W”.

Referring back to the description on the functional configuration of the BIOS memory 15 illustrated in FIG. 2, descriptions will be made on the priority setting information 46. The priority setting information 46 is information on the priority selected (set) by the user in relation to an allocation of processes to the CPUs 10. In the present embodiment, the user may set power consumption or performance as priority characteristics. Specifically, it is assumed that the user may select any of power saving, high performance, and default, as priority options. At the time of first start-up (factory shipment), it is assumed that the priority setting information 46 is set to default.

In the present embodiment, it is assumed that while the start-up program 41 is executed, the user sets the priority on the present information processing apparatus 1, via, for example, a BIOS screen. A method of setting the priority by using the start-up program 41 is known, and thus, descriptions thereof will be omitted herein.

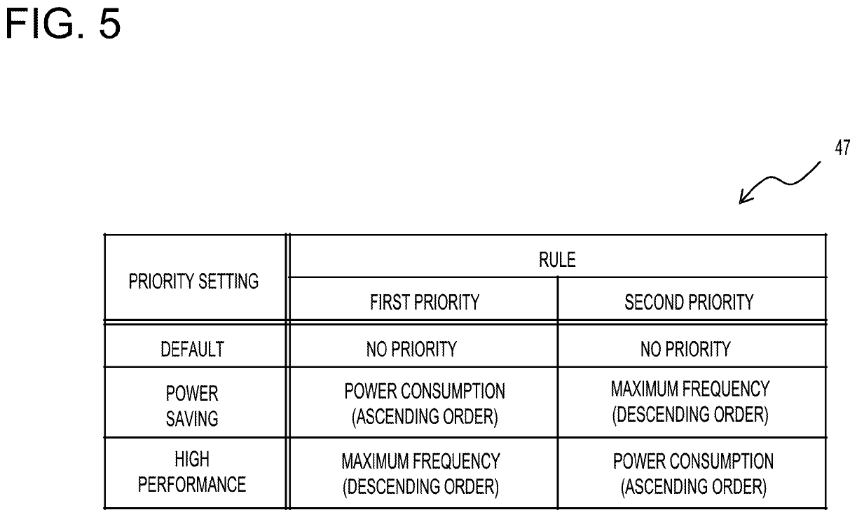

FIG. 5 is a view illustrating the prioritization rule definition 47 in the information processing apparatus 1 as an example of the embodiment. In the present embodiment, in the example illustrated in FIG. 5, the prioritization rule definition 47 is expressed in a table format. However, the expression format of information stored in the prioritization rule definition 47 is not limited to a table, and may be implemented through various modifications.

It is assumed that the prioritization rule definition 47 is previously defined by, for example, an administrator of the information processing apparatus 1 prior to an operation, and changes may be properly made during the operation. The prioritization rule definition 47 is also simply referred to as rule definition.

The prioritization rule definition 47 illustrated in FIG. 5 includes a “priority setting” and a “rule” as fields. The “rule” field further includes two fields of a “first priority” and a “second priority.”

The “priority setting” field of the prioritization rule definition 47 corresponds to a priority option selected by the user. In the present embodiment, the user may select any of “default,” “power saving,” and “high performance” as the priority options, and thus, a “default”, a “power saving”, and a “high performance” are stored in the “priority setting” field according to selection of the user. The priority options are also referred to as operating modes, and the “default,” the “power saving,” and the “high performance” are also referred to as an operating mode 1, an operating mode 2, and an operating mode 3, respectively.

The “first priority” field of the prioritization rule definition 47 stores a top-priority (first preferential) characteristic corresponding to a value stored in the “priority setting” field. The top-priority characteristic is also referred to as a priority characteristic, or a first priority characteristic.

The “second priority” field of the prioritization rule definition 47 stores a preferential (second preferential) characteristic subsequently to the characteristic set as the “first priority,” which corresponds to a value stored in the “priority setting” field. The second preferential characteristic is also referred to as a second priority characteristic.

The prioritization rule definition 47 illustrated in FIG. 5 defines a top-priority characteristic and a second priority characteristic, that is, the ranking of a plurality of characteristics, according to a priority option selected by the user. In the information processing apparatus 1, information of the CPU management information 45 is sorted according to the definition. That is, the prioritization rule definition 47 defines a key to be prioritized when the information of the CPU management information 45 is sorted.

When the values of the top-priority characteristic are the same (values stored in the “first priority” field of the prioritization rule definition 47 are the same), on the basis of a characteristic stored in the “second priority,” the information of the CPU management information 45 is sorted.

For example, in FIG. 5, when the user selects the priority (option) of the “power saving,” information of the CPU management information 45 is sorted with a “power consumption (ascending order)” as the top-priority characteristic (first priority), and a “maximum frequency (descending order)” as the second priority characteristic (second priority). That is, the information of the CPU management information 45 is sorted such that the core 11 with less power consumption is preferentially allocated to a process.

In FIG. 5, when the user selects the priority (option) of the “high performance,” information of the CPU management information 45 is sorted with a “maximum frequency (descending order)” as the top-priority characteristic (first priority), and a “power consumption (ascending order)” as the second priority characteristic (second priority). That is, first, the information of the CPU management information 45 is sorted such that the core 11 with a higher maximum frequency is preferentially allocated to a process. Therefore, for the cores 11 with the same power consumption levels, the information of the CPU management information 45 is sorted such that the core 11 with a higher maximum frequency is preferentially allocated to a process.

For the cores 11 with the same maximum frequencies, the information of the CPU management information 45 is sorted such that the core 11 with less power consumption is preferentially allocated to a process.

In FIG. 5, when the user selects the priority (option) of the “default,” information of the CPU management information 45 is not sorted. That is, the core 11 having a smaller value stored in the “logical core number” field of the CPU management information 45 is preferentially allocated to a process.

Referring back to the description in FIG. 2, the storage 13 of the information processing apparatus 1 may include an OS 51 and CPU management information for OS 52.

The CPU management information for OS 52 is a copy of the CPU management information 45 stored in the BIOS memory 15. Accordingly, in the present embodiment, it is assumed that the CPU management information for OS 52 includes the same fields as those of the CPU management information 45 illustrated in FIG. 4, and the same values are stored in each field.

The CPU management information for OS 52 is used when an allocation unit 61 to be described below allocates each core 11 provided in each CPU 10 to each process input by the user. At the time of first start-up of the information processing apparatus 1, it is assumed that “NULL” is stored as a value of each field of the CPU management information for OS 52. A method of allocation to processes using the CPU management information for OS 52 by the allocation unit 61 will be described below.

Referring back to the description in FIG. 2, in the information processing apparatus 1, the BIOS processor 21 may include a power on self test (POST) execution unit 31, a CPU management information generator 32, a CPU change checking unit 33, a characteristic measurement unit 34, a sorting unit 35, and a CPU management information update unit 36.

In the present embodiment, the BIOS processor 21 is implemented by the primary CPU 10 among the plurality of CPUs 10 mounted in the information processing apparatus 1. When the primary CPU 10 executes the start-up program 41, functions of the POST execution unit 31, the CPU management information generator 32, the CPU change checking unit 33, the characteristic measurement unit 34, the sorting unit 35, and the CPU management information update unit 36 are implemented.

The POST execution unit 31 executes a POST processing to perform a processing such as checking or initialization of the information processing apparatus 1 or a circuit of the corresponding information processing apparatus 1, etc. Such a POST processing is known, and thus, descriptions thereof will be omitted herein.

The CPU management information generator 32 generates the CPU management information 45 illustrated in FIG. 4. Specifically, the CPU management information generator 32 stores values in relation to each CPU 10 and each core 11, in the fields of the “physical CPU number,” the “physical core number,” the “HT number,” and the “logical core number” of the CPU management information 45. These values in relation to each CPU 10 or each core 11 may be acquired by a known method, and thus descriptions thereof will be omitted herein. The CPU management information generator 32 stores “NULL” in each of the “maximum frequency” and the “power consumption” of the CPU management information 45.

The CPU change checking unit 33 accesses each CPU 10 mounted in the information processing apparatus 1, and acquires each serial number. Such a serial number may be acquired by a known method, and thus descriptions thereof will be omitted herein. In the present embodiment, the CPU change checking unit 33 acquires the serial number, as information that specifies each CPU 10, but the information that specifies the CPU 10 is not limited thereto.

The CPU change checking unit 33 compares a serial number of each CPU 10, which is stored in the CPU identification information 44 (see, e.g., FIG. 3) of the BIOS memory 15, to a serial number of each CPU 10, which is acquired by accessing each CPU 10, so as to check whether these serial numbers are the same.

The characteristic measurement unit 34 measures characteristics of each core 11 provided in each CPU. In the present embodiment, it is assumed that the characteristic measurement unit 34 causes each core 11 to execute the characteristic measurement program 42 stored in the BIOS memory 15, thereby measuring a maximum frequency and a power consumption of each core 11, as characteristics.

Further, the characteristic measurement unit 34 stores the measured maximum frequency and the measured power consumption of each core 11, in the CPU management information 45 stored in the BIOS memory 15.

The sorting unit 35 sorts the CPU management information 45 stored in the BIOS memory 15 on the basis of a priority (option) selected by the user. Specifically, the sorting unit 35 sorts the allocation order of the respective cores 11 of the CPU 10 to conform to the order according to the priority selected by the user.

The CPU management information update unit 36 transmits the CPU management information 45 stored in the BIOS memory 15, to a CPU management information rewriting unit 62 of the OS processor 22.

As illustrated in FIG. 2, the OS processor 22 may include the allocation unit 61, the CPU management information rewriting unit 62, and a priority setting change receiver 63. In the present embodiment, the OS processor 22 is implemented by the primary CPU 10 among the plurality of CPUs 10 mounted in the information processing apparatus 1. When the primary CPU 10 executes the OS 51 stored in the storage 13, functions of the allocation unit 61, the CPU management information rewriting unit 62, and the priority setting change receiver 63 are implemented.

The allocation unit 61 allocates each core 11 provided in each CPU 10, to each process input by the user. In the allocation of the respective cores 11, the allocation unit 61 allocates the cores 11 to the processes with reference to the CPU management information for OS 52.

The CPU management information rewriting unit 62 receives the CPU management information 45 transmitted from the CPU management information update unit 36 of the BIOS processor 21, and updates the CPU management information for OS 52 stored in the storage 13. In this update, the CPU management information rewriting unit 62 may detect a difference between the received CPU management information 45 and the CPU management information for OS 52 stored in the storage 13, and may write information in relation to the detected difference from the CPU management information 45.

The priority setting change receiver 63 receives a changing request in relation to a priority option from the user.

### Processing at the Time of Start-Up in Information Processing Apparatus according to Embodiment

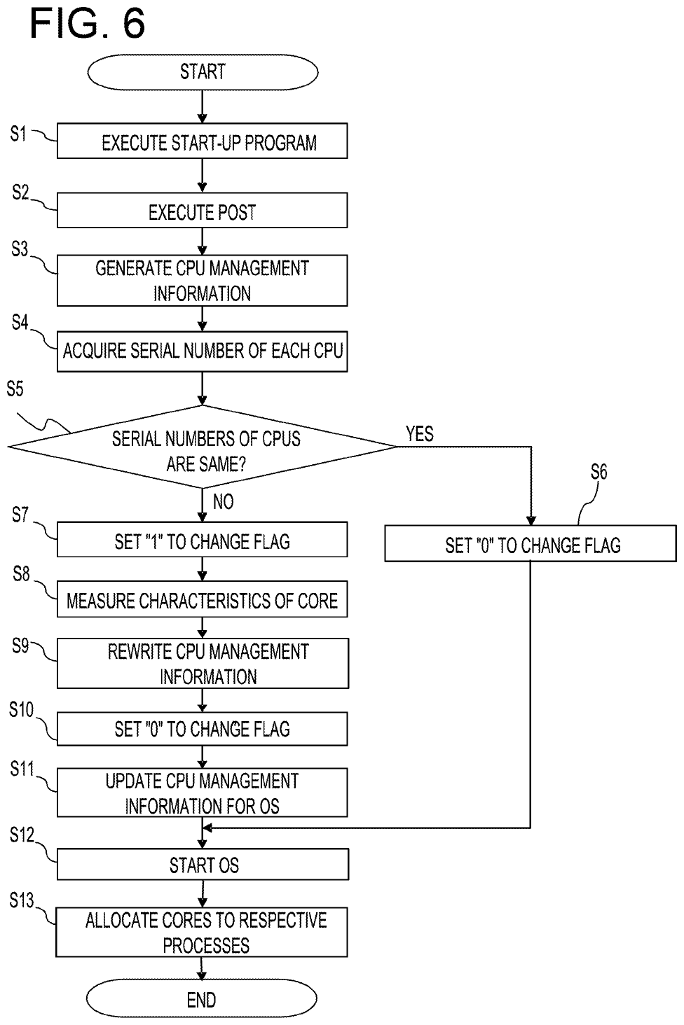

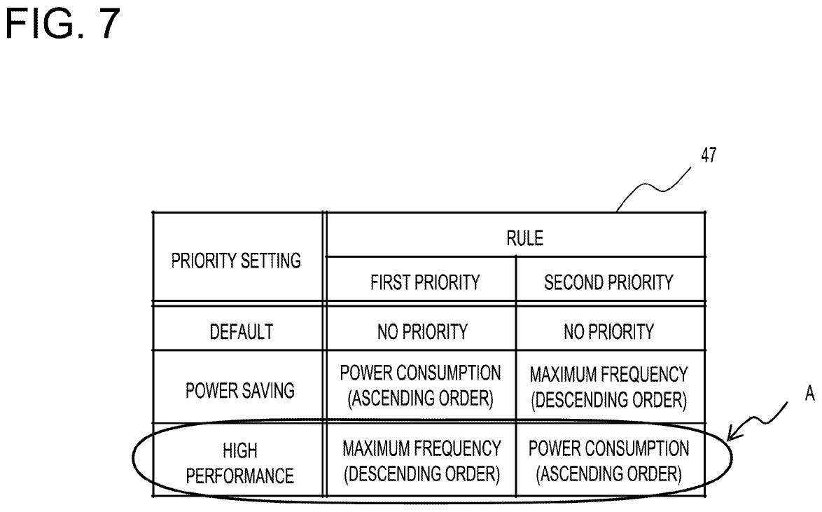

As an example of the embodiment configured as described above, an example of a processing at the time of start-up in the information processing apparatus 1 will be described according to a flowchart illustrated in FIG. 6 (steps S1 to S13), with reference to FIG. 7.

In the example described below, it is assumed that the number of the CPUs 10 provided in the information processing apparatus 1 is four, that is, the CPU#0 (10-0), the CPU#1 (10-1), the CPU#2 (10-2), and the CPU#3 (10-3), and each includes two cores 11.

FIG. 6 is a flowchart for explaining a processing at the time of start-up in the information processing apparatus 1 according to the embodiment. It is assumed that the processing illustrated in FIG. 6 is started by powering-ON of the information processing apparatus 1 by the user, as a trigger. In the present embodiment, it is assumed that the user turns ON the power of the information processing apparatus 1 by pressing a power button on the information processing apparatus 1.

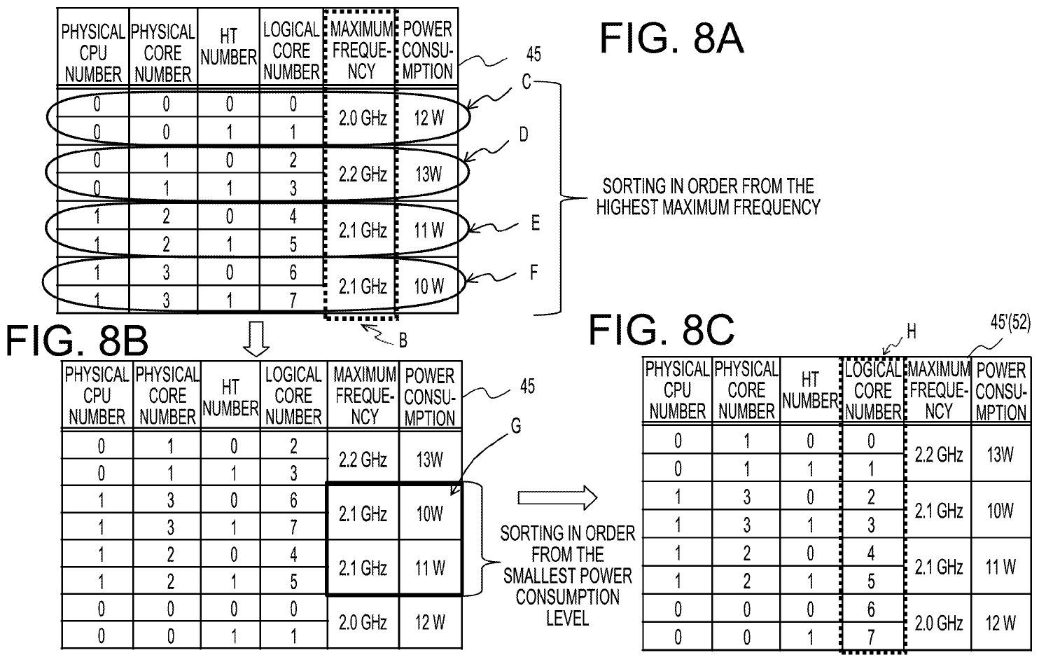

FIG. 7 is a view illustrating the prioritization rule definition 47 in the present embodiment, and FIGS. 8A to 8C are views illustrating rewriting of the CPU management information 45 in the present embodiment.

In step S1, the power-ON of the information processing apparatus 1 by the user is accepted, and the start-up program 41 stored in the BIOS memory 15 is executed.

Subsequently, in step S2, the POST execution unit 31 executes a POST processing to perform a processing such as checking or initialization of the information processing apparatus 1 or a circuit of the corresponding information processing apparatus 1, etc.

Subsequently, in step S3, the CPU management information generator 32 generates the CPU management information 45. Specifically, the CPU management information generator 32 collects, for example, information of each CPU 10, and stores values in relation to each CPU 10 or each core 11, in the fields of the “physical CPU number,” the “physical core number,” the “HT number,” and the “logical core number” of the CPU management information 45 of each CPU 10. The CPU management information generator 32 stores “NULL” as values of the “maximum frequency” and the “power consumption” of the CPU management information 45.

Subsequently, in step S4, the CPU change checking unit 33 accesses each CPU 10 mounted in the corresponding information processing apparatus 1 to acquire each serial number.

Subsequently, in step S5, for each physical CPU number, the CPU change checking unit 33 compares a serial number of each CPU 10, which is stored in the CPU identification information 44 of the BIOS memory 15, to the serial number of each CPU 10, which is acquired in step S4. Specifically, the CPU change checking unit 33 determines whether the serial number stored in the CPU identification information 44 and the serial number acquired in step S4 are all the same (i.e., whether there is no difference).

In step S5, when the CPU change checking unit 33 determines that the serial numbers are the same (see “Yes” route in step S5), that is, when there is no change in the configuration of the CPU 10 provided in the corresponding information processing apparatus 1, the processing proceeds to step S6.

In step S6, the CPU change checking unit 33 sets “0” to the effect that there is no change, to a value of the change flag 43 of the BIOS memory 15, and the processing proceeds to step S12.

Meanwhile, in step S5, when the CPU change checking unit 33 determines that the serial numbers are not the same (see “No” route in step S5), that is, when it is determined that there is a change in the configuration of the CPU 10, the processing proceeds to step S7.

In step S7, the CPU change checking unit 33 sets “1” to the effect that there is a change, to the value of the change flag 43 of the BIOS memory 15. At the same time, for the CPU 10 for which the serial numbers are determined not to be the same, the CPU change checking unit 33 stores the serial number acquired in step S4, in the “CPU serial number” field of the CPU identification information 44. As necessary, the CPU change checking unit 33 deletes information on the CPU 10 which is not provided in the corresponding information processing apparatus 1, from the CPU identification information 44. Accordingly, latest information of the CPU 10 provided in the information processing apparatus 1 is stored in the CPU identification information 44.

In this manner, through the above described operations in steps S4 to S7, when there is a change in the configuration of the CPU 10 provided in the information processing apparatus 1 due to exchanging, etc. of the CPU 10 after a previous-time CPU management table is created, “1” is stored in the value of the change flag 43. Then, for the CPU 10 after the change, a characteristic measurement is carried out as described below.

Meanwhile, even after the previous-time CPU management table is created, when there is no change in the configuration of the CPU 10 provided in the information processing apparatus 1, “0” is stored in the value of the change flag 43, and a characteristic measurement is skipped.

At the time of first start-up (factory shipment) of the information processing apparatus 1, “NULL” is stored in the “CPU serial number” field for each CPU 10 in the CPU identification information 44. Thus, in step S5, when comparing the serial number (“NULL”) of each CPU 10, which is stored in the CPU identification information 44, to the serial number of each CPU 10, which is acquired in step S4, the CPU change checking unit 33 determines that the serial numbers are not the same. Accordingly, at the time of first start-up of the information processing apparatus 1, it is determined that the serial numbers are not the same in step S5, and the following characteristic measurement is carried out.

When “1” is set to the value of the change flag 43 of the BIOS memory 15 in step S7, the processing proceeds to step S8, and in step S8, the characteristic measurement of the CPU 10 is carried out by the characteristic measurement unit 34.

In step S8, the characteristic measurement unit 34 causes each core 11 to execute the characteristic measurement program 42 stored in the BIOS memory 15 so as to measure characteristics of each core 11 provided in each CPU 10. In the present embodiment, it is assumed that the characteristic measurement unit 34 measures a maximum frequency and a power consumption of each core 11 as characteristics of each core 11. For example, the core 11 that has executed the characteristic measurement program 42 outputs the maximum frequency and the power consumption as measurement results to the characteristic measurement unit 34.

The characteristic measurement unit 34 stores the maximum frequency and the power consumption of each core 11, which are measured in step S8, in the “maximum frequency” field and the “power consumption” field of the CPU management information 45 stored in the BIOS memory 15, respectively.

FIG. 8A illustrates the maximum frequency and the power consumption of each core 11, which are measured in step S8. FIG. 8A illustrates that, for example, among the cores 11 provided in the CPU#0 (the CPU 10-0) having “0” as the physical CPU number, the core 11 having “0” as the physical core number was measured, and as a result, the maximum frequency was 2.0 GHz, and the power consumption was 12 W.

Subsequently, in step S9, the sorting unit 35 checks a priority option selected by the user with reference to the priority setting information 46 stored in the BIOS memory 15. That is, the sorting unit 35 checks which of power saving, high performance, and default is the characteristic to which the user gives a priority.

In the present embodiment, as an example, as illustrated in FIG. 7, descriptions will be made on a case where the priority option selected by the user is the “high performance” (see mark “A” in FIG. 7).

In step S9, the sorting unit 35 acquires information on a top-priority characteristic (first priority) and a second priority characteristic (second priority), which corresponds to the priority option (“high performance”) selected by the user, with reference to the prioritization rule definition 47 (FIG. 5). That is, in FIG. 7, the top-priority characteristic (first priority) is a “maximum frequency (descending order)” and the second priority characteristic (second priority) is “power consumption (ascending order).”

The sorting unit 35 sorts information in the CPU management information 45 on the basis of the top-priority characteristic (first priority) in the prioritization rule definition 47. In the present example, since the top-priority characteristic is the “maximum frequency (descending order),” the sorting unit 35 sorts records of the physical cores 11 (see marks “C” to “F” in FIG. 8A) such that maximum frequencies (see mark “B” in FIG. 8A) are arranged in a descending order.

FIG. 8B illustrates the results when the records of the (physical) cores 11 are sorted in order from the highest maximum frequency. As indicated by the mark “G” in FIG. 8B, as a result of characteristic measurement, the maximum frequencies of the core 11 having “3” as the physical core number, and the core 11 having “2” as the physical core number have the same values (2.1 GHz). Therefore, the sorting unit 35 sorts the records of the (physical) cores 11 on the basis of the “power consumption (ascending order)” as the second priority characteristic (second priority). That is, in FIG. 8B, the record of the core 11 having “3” as the physical core number and the record of the core 11 having “2” as the physical core number are sorted in order from the smallest power consumption level, from the top.

In FIG. 8C, on the basis of the order of the physical cores 11, which is obtained in this manner, the sorting unit 35 stores “0” to “7” as values in the “logical core number” field of the CPU management information 45, respectively, in order from the top (see mark “H” in FIG. 8C).

Through the operation in step S9, the records of the physical cores 11 are sorted on the basis of the priority selected by the user, and an order of allocation to an optimum process is stored (set) in the “logical core number” field of the core 11. Thus, the CPU management information 45 is rewritten. That is, the value stored in the “logical core number” field indicates an allocation order of the core 11 according to the priority selected by the user, on the basis of a plurality of characteristics.

Subsequently, in step S10, the CPU change checking unit 33 sets “0” to the value of the change flag 43 of the BIOS memory 15. Accordingly, it is possible to avoid carrying out the characteristic measurement of the CPU 10 again at the time of next-time start-up.

Subsequently, in step S11, the CPU management information update unit 36 transmits the CPU management information 45 generated in step S9, to the CPU management information rewriting unit 62 of the OS processor 22.

The CPU management information rewriting unit 62 that has received the CPU management information 45 generated in step S9 updates the CPU management information for OS 52 by using the changed values in the CPU management information 45.

Through the operation in step S11, it is possible to synchronize the CPU management information 45 stored in the BIOS memory 15, with the CPU management information for OS 52 stored in the storage 13. In the CPU management information 45 stored in the BIOS memory 15, the physical cores 11 are sorted in the optimum order through the execution of the start-up program 41. Thus, the optimum order is also reflected on the CPU management information for OS 52 stored in the storage 13.

Subsequently, in step S12, the primary CPU 10 starts an OS. Accordingly, among the operations subsequently to step S12, operations on functions implementable by the OS are handed over to the OS processor 22 (OS) from the BIOS processor 21 (the start-up program 41). That is, steps 51 to S11 illustrated in FIG. 6 are implemented by the BIOS processor 21 (the start-up program 41) and steps S12 to S13 illustrated in FIG. 6 (to be described below) are implemented by the OS processor 22 (OS).

Subsequently, in step S13, the allocation unit 61 performs an allocation of the cores 11 to respective processes with reference to the CPU management information for OS 52. Then, the processing is ended.

As described above, in the information processing apparatus 1 of the present embodiment, it becomes possible to allocate the cores 11 to respective processes according to the allocation order stored in the “logical core number” field of the core 11, and it is possible to implement a processing on which characteristics of a priority selected by the user are reflected. Accordingly, it is possible to allocate the core 11 with power saving or high performance, to a process input by the user. Thus, in the information processing apparatus 1, it becomes possible to implement the processing with better power saving or higher performance.

In the information processing apparatus 1 of the present embodiment, through the operations in steps S4 to S8 illustrated in FIG. 6, when there is a change in a configuration of the CPU 10, the characteristic measurement unit 34 measures the characteristics of each core 11 of the CPU 10 provided in the corresponding information processing apparatus 1. Since a predetermined time is required for characteristic measurement, only in a case where there is a change in the configuration of the CPU 10, characteristics are measured. Thus, an unnecessary characteristic measurement may be avoided.

In a rack service provided by a data center etc. (rack rental), there are some cases where the user is charged for the amount of used electric power. Therefore, through the selection of a power saving option by a provider of such a service, it becomes possible to provide the same level of service to the user with a less expensive cost.

In a night batch processing performed on the information processing apparatus 1, through the selection of a high performance option, it becomes possible to allocate the core 11 with high performance to a process, and shorten a time required for the batch processing.

In the scheduling of the information processing apparatus 1, the user sets a priority of high performance during the daytime (e.g., at 8:00 to 18:00) so that the performance of a processing such as on-line transactions executed during the daytime is emphasized. The user sets a priority of high performance even at night (e.g., after 18:00) so that it becomes possible to allocate the core 11 with high performance to a process, and shorten a time required for the batch processing.

### Control Processing in Running state of Information Processing Apparatus According to Embodiment

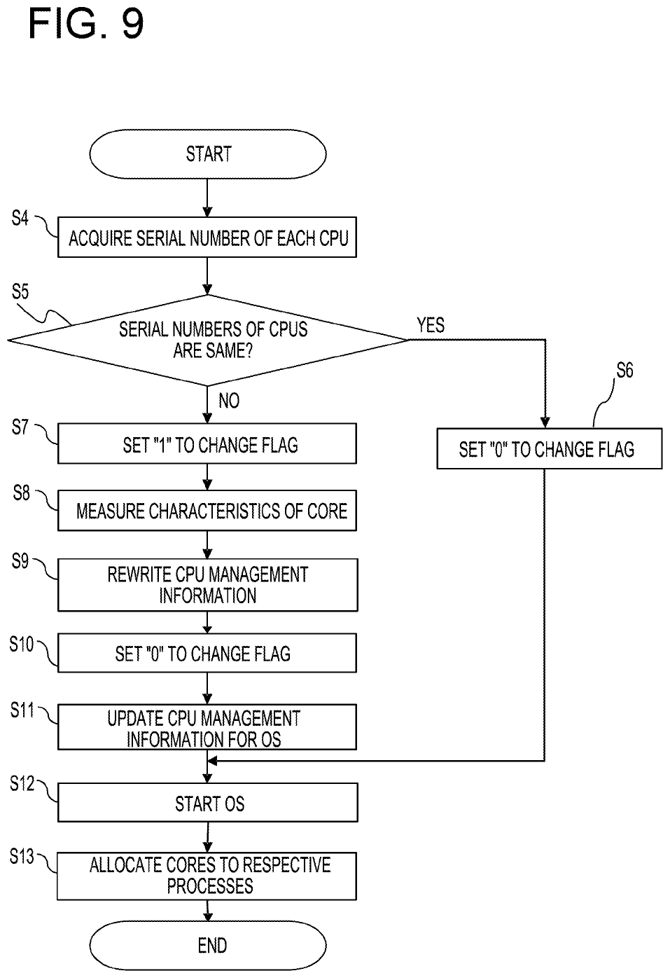

In FIGS. 6 and 7 as described above, descriptions have been made on a control processing triggered when the user turns ON the power of the information processing apparatus 1. In the embodiment exemplified in FIGS. 6 and 7, there are some cases where the user adds the CPU 10 or changes a part of the CPUs 10 in a running state (active state) of the information processing apparatus 1 without shutting off the power of the information processing apparatus 1. Therefore, in the present embodiment, descriptions will be made on a control processing performed in the above described case with reference to a flowchart illustrated in FIG. 9 (steps S4 to S13).

FIG. 9 is a flowchart for explaining a control processing in a running state in the information processing apparatus 1 according to the embodiment.

In FIG. 9, operations given the same numerals as the already described numerals indicate the same operations, and thus specific descriptions thereof will be omitted.

It is assumed that the control processing illustrated in FIG. 9 is started by execution of the CPU change checking unit 33 by the user through, for example, the start-up program 41, as a trigger. Thus, when the user requests execution of the CPU change checking unit 33 from the input unit 23 via, for example, an interface of the start-up program 41 (e.g., the BIOS screen), the start-up program 41 executes the CPU change checking unit 33. Then, by the trigger, an operation in step S4 illustrated in FIG. 9 is started.

Through the operations in S4 to S13 illustrated in FIG. 9, the CPU management information rewriting unit 62 generates the CPU management information for OS 52 on which the CPU 10 according to a changed configuration is reflected. On the basis of the generated CPU management information for OS 52, the allocation unit 61 allocates the cores 11 to processes. Then, the processing is ended.

As described above, in the information processing apparatus 1 of the present embodiment, when the user executes the start-up program 41 in the running state of the corresponding information processing apparatus 1, the CPU management information for OS 52 is updated, and then on the basis of the updated CPU management information for OS 52, the cores 11 are allocated to processes. Accordingly, even when adding the CPU 10 or changing a part of the CPUs 10 without shutting off the power of the information processing apparatus 1, the user may implement an allocation of the cores 11 to processes on the basis of the updated characteristics of the core 11 without restarting the information processing apparatus 1.

### <Control Processing According to Characteristic Re-Measurement in Information Processing Apparatus According To Embodiment

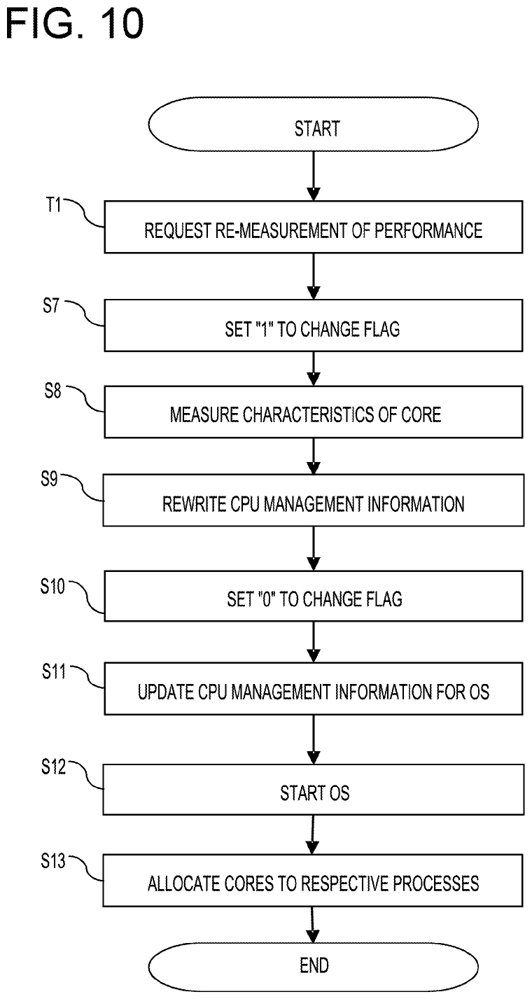

In the embodiment exemplified in FIGS. 6 and 7, there are some cases where the user requests a characteristic measurement of the core 11 again in a running state of the information processing apparatus 1 without shutting off the power of the information processing apparatus 1. Therefore, in the present embodiment, descriptions will be made on a control processing performed in the above described case with reference to a flow chart illustrated in FIG. 10 (steps T1 and S7 to S13).

FIG. 10 is a flowchart for explaining a control processing according to a characteristic re-measurement in the information processing apparatus 1 according to the embodiment.

In FIG. 10, operations given the same numerals as the already described numerals indicate the same operations, and thus specific descriptions thereof will be omitted.

In step T1 illustrated in FIG. 10, for example, the user requests a characteristic re-measurement of the core 11 through the start-up program 41. Specifically, the user requests an execution of the characteristic measurement unit 34 from the input unit 23 via, for example, an interface of the start-up program 41 (e.g., the BIOS screen). Upon receiving the request, the start-up program 41 executes the characteristic measurement unit 34 so as to re-measure the characteristics of the core 11.

Subsequently, through the operations in S7 to S13, the characteristic measurement unit 34 re-measures the characteristics of the core 11. Then, the CPU management information rewriting unit 62 generates the CPU management information for OS 52 on which results of the re-measurement are reflected. On the basis of the generated CPU management information for OS 52, the allocation unit 61 performs an allocation of the cores 11 to processes again, and the processing is ended.

As described above, in the information processing apparatus 1 of the present embodiment, when the user executes the characteristic measurement unit 34 through the start-up program 41 in the running state of the corresponding information processing apparatus 1, the CPU management information for OS 52 is updated on the basis of results of characteristic re-measurement of the core 11. The allocation unit 61 allocates the cores 11 to processes on the basis of the updated CPU management information for OS 52. Accordingly, when the user wants to re-measure the characteristics of the core 11, the user may perform the characteristic re-measurement of the core 11 without restarting the information processing apparatus 1. On the basis of the re-measurement results, it is possible to implement a re-allocation of the cores 11 to processes.

### <Control Processing According to Change of Priority Setting Information in Information Processing Apparatus According to Embodiment

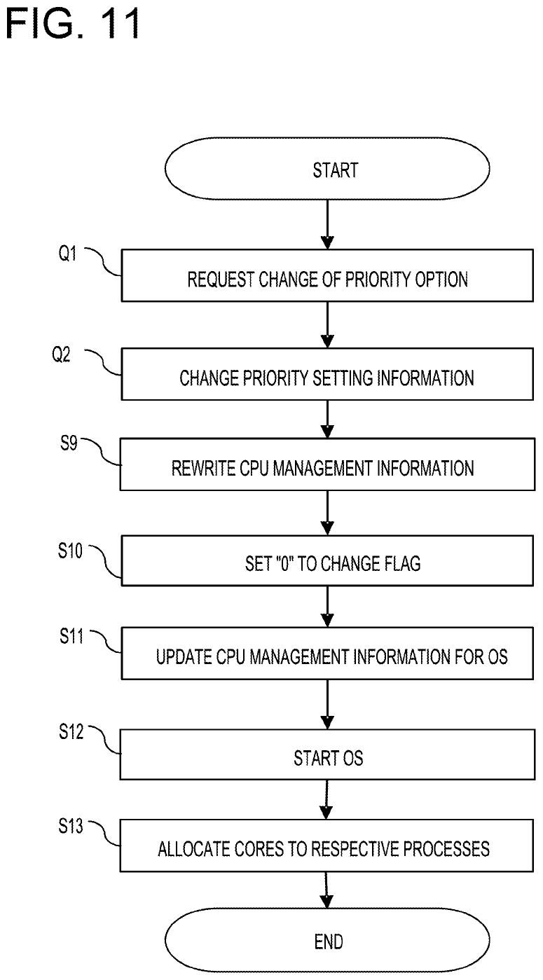

In the embodiment exemplified in FIGS. 6 and 7, there are some cases where the user requests a change of a priority option in a running state of the information processing apparatus 1. Therefore, in the present embodiment, descriptions will be made on a control processing performed in the above described case with reference to a flowchart illustrated in FIG. 11 (steps Q1 to Q2 and S9 to S13).

FIG. 11 is a flowchart for explaining a control processing according to a change of the priority setting information 46 in the information processing apparatus 1 according to the embodiment.

In FIG. 11, operations given the same numerals as the already described numerals indicate the same operations, and thus specific descriptions thereof will be omitted.

In step Q1 illustrated in FIG. 11, the user requests a change of a priority option from, for example, the input unit 23. For example, it is assumed that the user inputs a priority option (changed option) desired by the user through a predetermined application or interface running on the OS 51.

Subsequently, in step Q2, upon receiving this request of the user, the priority setting change receiver 63 of the OS processor 22 stores the (changed) priority option desired by the user, in the priority setting information 46.

Subsequently, through the operations in steps S9 to S13, the sorting unit 35 sorts the CPU management information 45 on the basis of the changed priority option. Then, the CPU management information rewriting unit 62 generates (rewrites) the CPU management information for OS 52 on which the changed priority option is reflected. The allocation unit 61 performs (resets) an allocation of the cores 11 to processes again on the basis of the generated CPU management information for OS 52, and the processing is ended.

As described above, in the information processing apparatus 1 of the present embodiment, when the user requests a change of the priority option in the running state of the corresponding information processing apparatus 1, reallocation of the cores 11 to processes is performed on the basis of the changed priority option. Accordingly, it becomes possible to allocate the processes to the cores 11 in consideration of changed characteristics desired by the user.

### Modification of Embodiment

In FIGS. 6 to 11 as described above, descriptions have been made on a processing of controlling allocation of the cores 11 to processes in the information processing apparatus 1. In the embodiment exemplified in FIGS. 6 to 11, there are some cases where it is confirmed in advance that there is almost no difference in characteristics between the respective cores 11 provided in the respective CPUs 10. In such a case, the processing performance or power consumption of a process may be affected by the difference in characteristics of the CPUs 10 rather than the difference in characteristics of the cores 11. Therefore, under such a circumstance, control for allocation of the CPUs 10 to processes may be desirable instead of control for allocation of the cores 11. Accordingly, in the present modification, in the above described case, a processing of controlling allocation of the CPUs 10 to processes is performed.

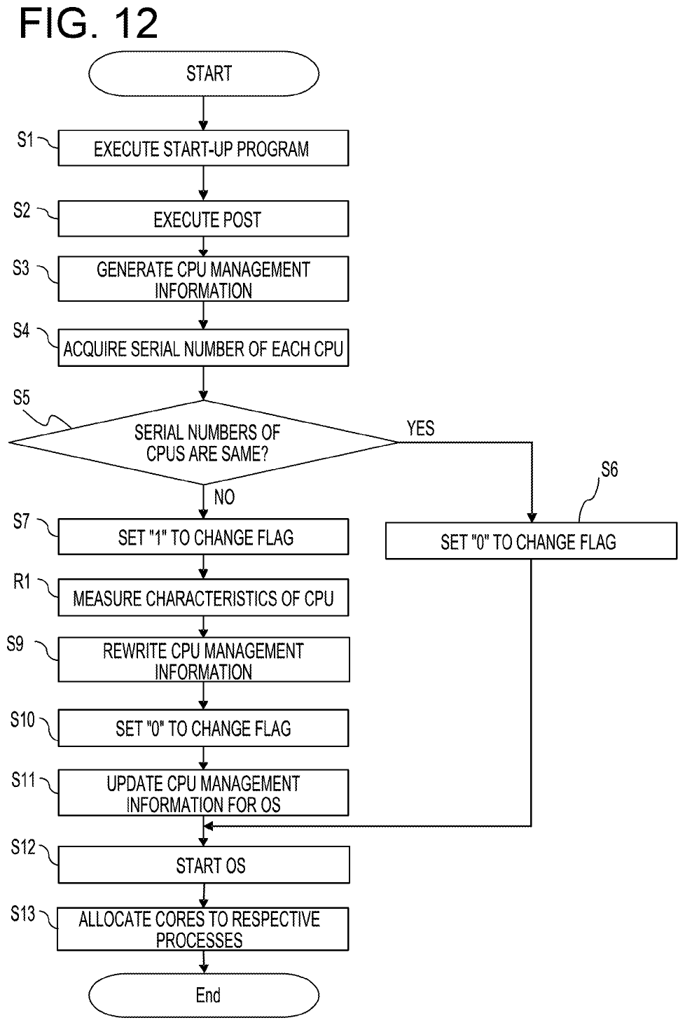

In the present modification, descriptions will be made on a control processing performed in the above described case, according to a flowchart illustrated in FIG. 12 (steps S1 to S7, R1, and S9 to S13) with reference to FIGS. 12, 13, 14A and 14B. In the present modification, it is assumed that there are four CPUs 10 (CPU#0, CPU#1, CPU#2, and CPU#3), and each of the CPUs 10 includes two cores 11.

FIG. 12 is a flowchart for explaining a control processing in the information processing apparatus 1 according to the modification.

In FIG. 12, operations given the same numerals as the already described numerals indicate the same operations, and thus specific descriptions thereof will be omitted.

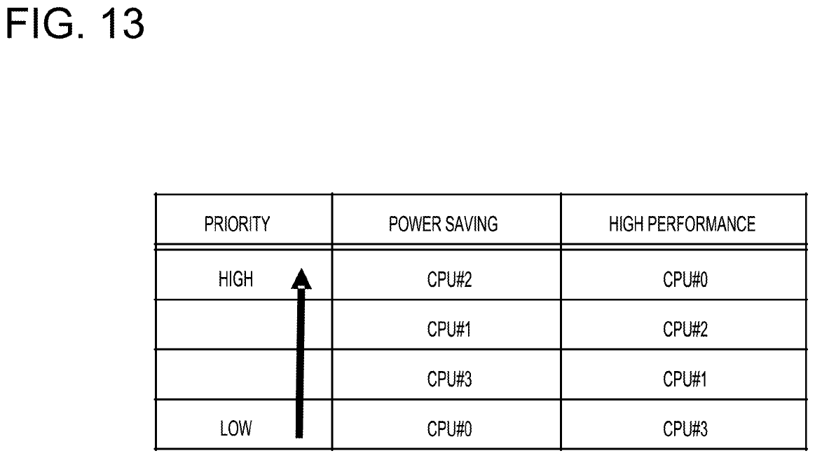

FIG. 13 is a view illustrating the results obtained when the characteristic measurement unit 34 measures characteristics of each CPU 10 in the information processing apparatus 1 according to the modification.

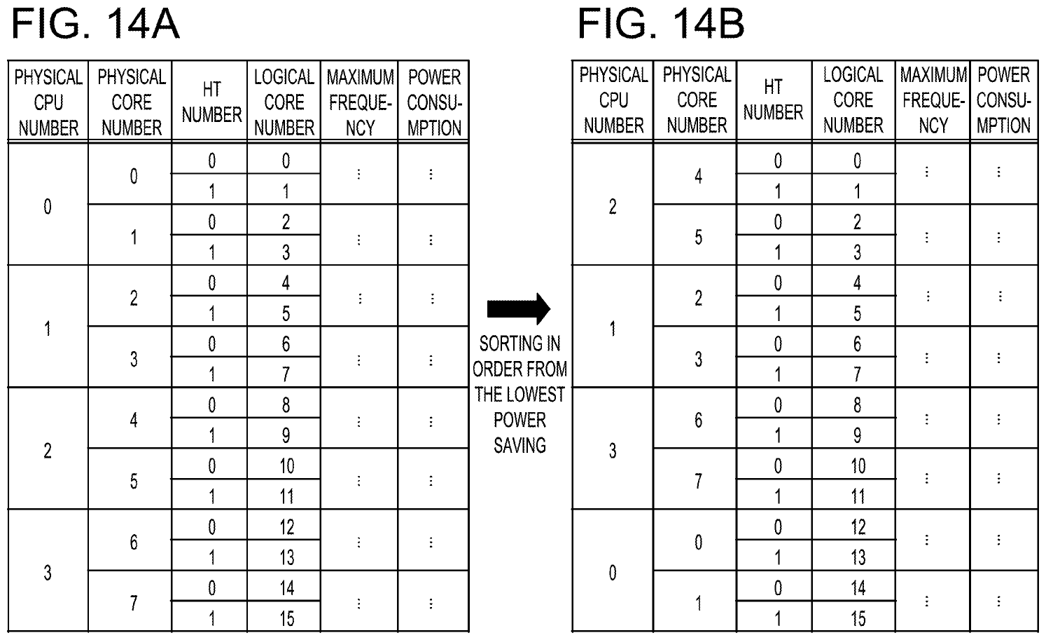

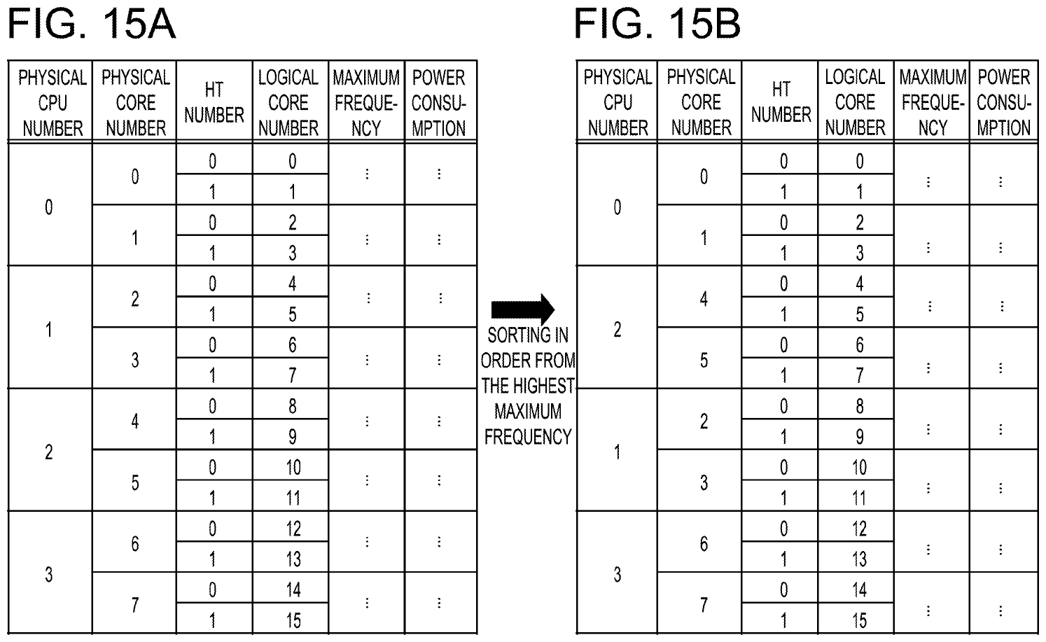

FIGS. 14A and 14B, and FIGS. 15A and 15B are views illustrating rewriting of the CPU management information 45, in the information processing apparatus 1 according to the modification.

As illustrated in FIG. 12, after operations in steps S1 to S4, in step S5, when the CPU change checking unit 33 determines that the serial numbers are not the same (see “No” route in step S5), the processing proceeds to step S7. Subsequently, in step S7, the CPU change checking unit 33 sets “1” to the value of the change flag 43 of the BIOS memory 15.

Subsequently, in step R1, the characteristic measurement unit 34 causes each CPU to execute the characteristic measurement program 42 so as to measure characteristics of each CPU 10. The characteristic measurement unit 34 stores a maximum frequency and a power consumption of each CPU 10, which are measured in step R1, in the “maximum frequency” field and the “power consumption” field of the CPU management information 45 stored in the BIOS memory 15, respectively.

For example, FIG. 13 illustrates that as a result of characteristic measurement, the CPU 10 with the smallest power consumption level, that is, the CPU 10 with the highest power saving performance is the CPU#2, and thereafter, the power consumption increases in the order of the CPU#1, the CPU#3, and the CPU#0 (i.e., the power saving performance is lowered). FIG. 13 illustrates that as a result of characteristic measurement, the CPU 10 with the highest maximum frequency, that is, the CPU 10 with the highest performance is the CPU#0, and thereafter, the maximum frequency (performance) decreases in the order of the CPU#2, the CPU#1, and the CPU#3.

In the modification, the characteristic measurement program 42 is a program that measures the characteristics of each CPU 10, and, for example, causes each CPU 10 to execute a specific instruction sequence for a predetermined time. In the modification, it is assumed that a maximum frequency and a power consumption are measured as characteristics. A method or a program of measuring these characteristics (the maximum frequency and the power consumption) is known, and thus, descriptions thereof will be omitted herein.

Subsequently, in step S9, the sorting unit 35 sorts (records of) the CPUs 10 in the CPU management information 45, on the basis of the maximum frequency and the power consumption of each CPU 10, which are measured in step R1, and a priority selected by the user.

In step S9, descriptions will be made on a case where a priority option selected by the user is power saving, as an example. In this case, the sorting unit 35 sorts records of the respective CPUs 10 (the CPU#0 to the CPU#3) in the CPU management information 45 as illustrated in FIG. 14A, in order from the smallest power consumption level (the CPU#2, the CPU#1, the CPU#3, and the CPU#0). After this sorting is performed, values “0”,“1”,“2”, . . . are stored in order from the top (in order from the smallest power consumption level), in the “logical core number” field. Accordingly, the records of the CPUs 10 are sorted in an order that considers the power saving as the priority selected by the user (see, e.g., FIG. 14B).

In step S9, descriptions will be made on a case where a priority option selected by the user is high performance, as an example. In this case, the sorting unit 35 sorts the records of the respective CPUs 10 (the CPU#0 to the CPU#3) in the CPU management information 45 as illustrated in FIG. 15A, in an order from the highest maximum frequency (the CPU#0, the CPU#2, the CPU#1, and the CPU#3). After this sorting is performed, values “0”, “1” and “2”, . . . are stored in an order from the top (in order from the highest maximum frequency) in the “logical core number” field. Accordingly, the records of the CPUs 10 are sorted in an order that considers the high performance as the priority selected by the user (see, e.g., FIG. 15B).

Subsequently, through the operations in steps S10 to S13, the allocation unit 61 performs an allocation of the cores 11 to respective processes with reference to the CPU management information for OS 52 on which the allocation order of the CPUs 10 sorted in step S9 is reflected. Then, the processing is ended.

As described above, in the information processing apparatus 1 according to the modification, the characteristics of each CPU 10 are measured, the records of the CPUs 10 in the CPU management information for OS 52 are sorted on the basis of the measurement results, and an allocation of the CPUs 10 to respective processes is performed according to the sorted order. Accordingly, for example, when it is known, in advance, that a difference is not seen between the plurality of cores 11 provided in the CPUs 10, it becomes possible to perform a control in consideration of individual differences of the CPUs 10 instead of individual differences of the cores 11.

### Others

Then, the disclosed technology is not limited to the above described embodiment, and may be implemented through various modifications without departing from the spirit of the present embodiment. Respective configurations and respective processings in the present embodiment may be selected or may be properly combined as necessary.

In the above described embodiment, the CPU management information rewriting unit 62 receives the CPU management information 45, and updates the CPU management information for OS 52 stored in the storage 13 on the basis of the received CPU management information 45. However, the CPU management information for OS 52 may not be provided in the storage 13. In this case, the CPU management information rewriting unit 62 may create a copy of the received CPU management information 45, as the CPU management information for OS 52, and may store the CPU management information for OS 52 in the storage 13.

In the above described embodiment, characteristics are measured by causing each core 11 to execute the characteristic measurement program 42, but instead, information on the characteristics of each core 11 may be acquired from a baseboard management controller (BMC).

In the above described embodiment, descriptions have been made on an example in which characteristics of the core 11 are a maximum frequency and a power consumption, but the characteristics of the core 11 are not limited thereto. When it is assumed that the characteristics of the core 11 are others than the above, implementation through various modifications may be made by changing a program executed by the core 11.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a plurality of processors coupled to the memory, wherein one of the plurality of processors configured to
set an allocation order with respect to the plurality of processors based on an operating mode set in relation to a plurality of characteristics on the plurality of processors, and
allocate the plurality of processors to processes according to the allocation order.

2. The information processing apparatus according to claim 1, wherein the one of the plurality of processors is configured to:
refer to rule definition that defines priorities on the plurality of characteristics in association with the operating mode, and
set the allocation order based on a characteristic with a highest priority.

3. The information processing apparatus according to claim 1, wherein the one of the plurality of processors is configured to
when the one of the plurality of processors detects a change in a configuration of at least one processor among the plurality of processors, measure the plurality of characteristics with respect to the plurality of processors.

4. The information processing apparatus according to claim 1, wherein the one of the plurality of processors is configured to
when the one of the plurality of processors detects a change of the operating mode, set the allocation order with respect to the plurality of processors based on a changed operating mode.

5. A non-transitory computer-readable recording medium storing a program that causes one of a plurality of processors included in an information processing apparatus to execute a process, the process comprising:
setting an allocation order with respect to the plurality of processors based on an operating mode set in relation to a plurality of characteristics on the plurality of processors; and
allocating the plurality of processors to processes according to the allocation order.

6. The recording medium according to claim 5, wherein the process further comprising:
referring to rule definition that defines priorities on the plurality of characteristics in association with the operating mode; and
setting the allocation order based on a characteristic with a highest priority.

7. The recording medium according to claim 5, wherein the process further comprising
when the one of the plurality of processors detects a change in a configuration of at least one processor among the plurality of processors, measuring the plurality of characteristics with respect to the plurality of processors.

8. The recording medium according to claim 5, wherein the process further comprising
when the one of the plurality of processors detects a change of the operating mode, setting the allocation order with respect to the plurality of processors based on a changed operating mode.

9. A computer-implemented method comprising:
setting an allocation order with respect to a plurality of processors based on an operating mode set in relation to a plurality of characteristics on the plurality of processors; and
allocating the plurality of processors to processes according to the allocation order.

10. The method according to claim 9, further comprising:
referring to rule definition that defines priorities on the plurality of characteristics in association with the operating mode; and
setting the allocation order based on a characteristic with a highest priority.

11. The method according to claim 9, further comprising:
when the plurality of processors detects a change in a configuration of at least one processor among the plurality of processors, measuring the plurality of characteristics with respect to the plurality of processors.

12. The method according to claim 9, further comprising:
when the plurality of processors detects a change of the operating mode, setting the allocation order with respect to the plurality of processors based on a changed operating mode.
